(19) United States
(12) Patent Application Publication
(10) Pub. No.: US 2018/0354308 A1
(43) Pub. Date: Dec. 13, 2018

(54) TIRE WITH IMPROVED CROWN PORTION REINFORCEMENT

(71) Applicants: William Bennett CLAYTON, Greenville, NC (US); Daniel McEachern HICKS, Greenville, SC (US); Compagnie Generale des Etablissements Michelin, Granges-Paccot (CH)

(72) Inventors: William Bennett Clayton, Greenville, SC (US); Daniel McEachern Hicks, Greenville, SC (US)

(21) Appl. No.: 15/778,285

(22) PCT Filed: Dec. 12, 2016
(86) PCT No.: PCT/US16/66063

§ 371 Date: May 23, 2018

(30) Foreign Application Priority Data
Dec. 16, 2015 (US) PCT/US2015/065968

(51) Int. Cl. B60C 9/28; B60C 9/00; B60C 9/20

(52) U.S. Cl. CPC B60C 9/28; B60C 9/0007; B60C 9/0057; B60C 2009/2271; B60C 2009/2016; B60C 2009/2019; B60C 9/2006

(57) ABSTRACT

Pneumatic tire for heavy duty vehicles having a crown portion comprising two working plies (114,116) and a breaker ply (120) radially outward of the carcass body ply wherein the breaker ply (120) comprises a plurality of breaker ply reinforcement elements (122) having a length L of no more than 155 mm, at an angle of 5°<60°.

### PRIORITY STATEMENT

The present application claims priority under 35 U.S.C. § 119 to PCT/US15/065968, filed Dec. 16, 2015.

### FIELD OF THE INVENTION

The present invention relates to a tire having unique reinforcements in the crown portion.

### BACKGROUND OF THE INVENTION

The resistance of a tire to road hazards is an important aspect of time performance along with characteristics such as rolling resistance, traction, wear, and others. As used herein, road hazard performance refers to the tire's ability to impact an obstacle in the roadway without suffering critical structural damage along the crown portion of the tire. For example, during operation, the tire might encounter a rock, hole, or other hazard with potential to damage reinforcements in the crown portion of the tire.

One well-known test for road hazard performance is referred to as the breaking energy test (BE test) that is set forth by the United States Government as FMVSS 119 or DOT 119. In this test, a steel plunger is forced perpendicular to the tread of a mounted and inflated tire until the tire either ruptures (with the resulting air loss) or the plunger is stopped by reaching the rim. The plunger penetration distance and the force test points are then used to calculate a breaking energy that must exceed the required “minimum breaking energy” set by e.g., a governing or regulatory body. As such, the BE test is intended to measure the ability of the tire to absorb the energy associated with a road hazard impact.

Conventionally, various alternatives are available to improve a tire's road hazard performance. For example, one or more reinforcement layers can be added to the crown portion of the tire. The strength of cables in the reinforcement layers can be increased. The pace (i.e. spacing between) of the reinforcement cables in the reinforcement layers can be decreased. Typically, these potential solutions add considerable penalties in cost, mass, and/or rolling resistance of the tire.

Accordingly, a tire that can provide resistance to road hazards would be useful. More particularly, a tire than can provide resistance to road hazards while avoiding penalties in e.g., mass, cost, and or rolling resistance associated with conventional solutions would be particularly beneficial.

### SUMMARY OF THE INVENTION

The present invention relates to a tire that provides increased resistance to road hazards without incurring significant penalties in mass, cost, or rolling resistance. A least one ply, referred to herein as a “breaker ply,” is positioned radially outward of a body ply and includes reinforcements positioned at particular angle relative to the circumferential direction C or the equatorial plane EP of the tire. The width, W, of the breaking ply can be minimized based on the angle of its reinforcements so as to help reduce the mass, cost, and rolling resistance of the tire. Additional objects and advantages of the invention will be set forth in part in the following description, or may be apparent from the description, or may be learned through practice of the invention.

In one exemplary embodiment of the present invention, the present invention provides a tire defining axial, circumferential, and radial directions. The tire defines an equatorial plane. The tire includes a pair of opposing bead portions, a pair of opposing sidewall portions, wherein each sidewall portion is configured for connection to a rim of a wheel with a bead portion. A crown portion is connected between opposing sidewall portions. A body ply extends between the bead portions and through the opposing sidewall portions and crown portion.

A breaker ply is positioned in the crown portion and radially outward of the body ply. A first working ply is positioned in the crown portion and radially outward of the breaker ply. A second working ply is positioned in the crown portion and radially outward of the first working ply.

The breaker ply includes a plurality of breaker ply reinforcement elements having a length of no more than 155 mm, at an angle θ from the equatorial plane, wherein the range of θ is 5°≤θ≤60°.

The tire may include a layer of circumferential reinforcement elements positioned in the crown layer.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic, cross-sectional view of an exemplary embodiment of the present invention.

FIG. 2 is a schematic illustration depicting the relative angles of reinforcements in various layers or plies of an exemplary embodiment the present invention.

FIG. 3 is a schematic illustration depicting the relative angles of reinforcements in various layers or plies where the breaking ply has reinforcements positioned at 90 degrees from the equatorial plane.

FIG. 4 illustrates a schematic, cross-sectional view of another exemplary embodiment of the present invention.

FIGS. 5 through 8 illustrate plots of various experimental data as more fully described herein.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

As stated above, a tire's resistance to impact with road hazards can be measured using a breaking energy (BE) test such as FMVSS 119 or DOT 119, which are well known and published. One aspect of the inventors' present discovery is that the mass of reinforcements used in the crown portion of a tire can be reduced while actually improving the tire's resistance to road hazard performance. This discovery contradicts conventional methods whereby the mass of the tire is increased by adding belts to the tire, decreasing the pace (e.g., increasing the density) of cord reinforcements, and similar approaches that undesirably increase the rolling resistance and manufacturing cost of the tire.

As used herein:

Cords are “inextensible” when such cords have, under a tensile force equal to 10% of their breaking strength, a relative elongation of at most 0.2%.

“Pace” refers to the distance A between adjacent reinforcement elements in the layer of the reinforcing ply.

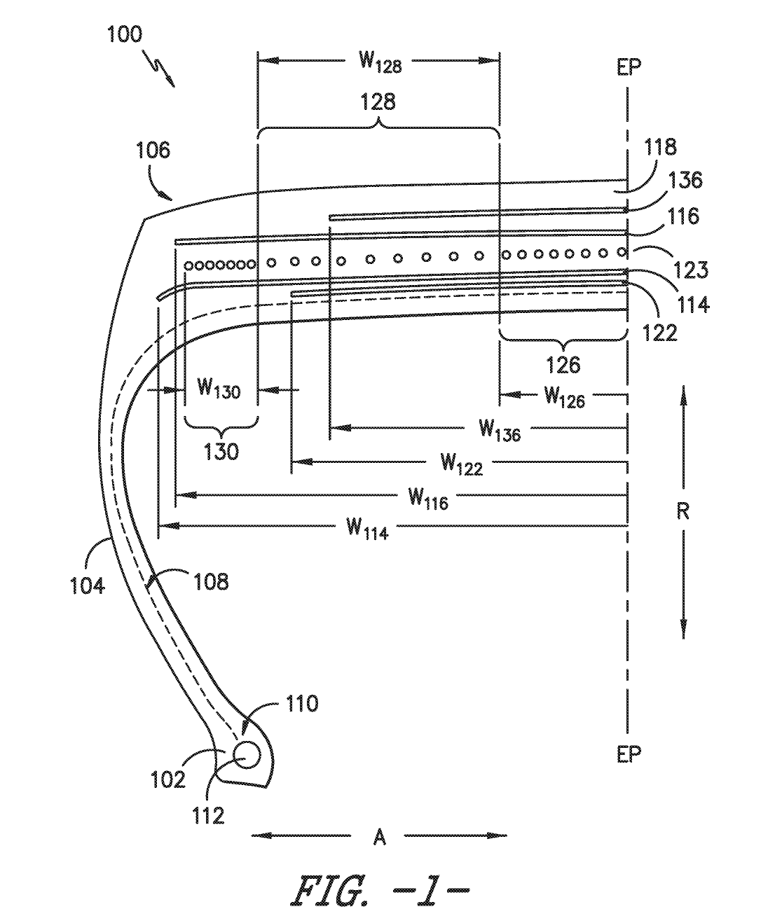

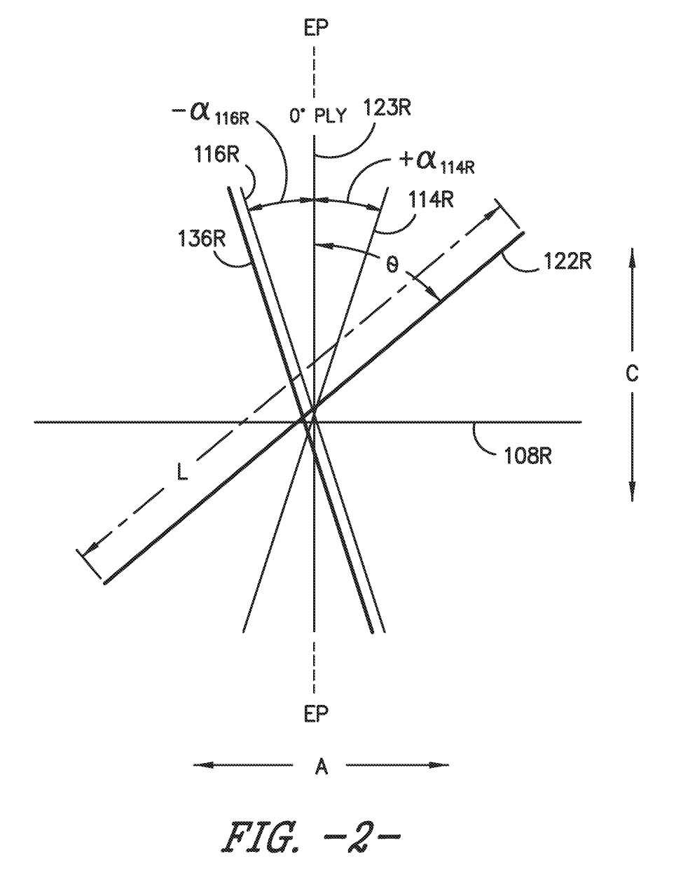

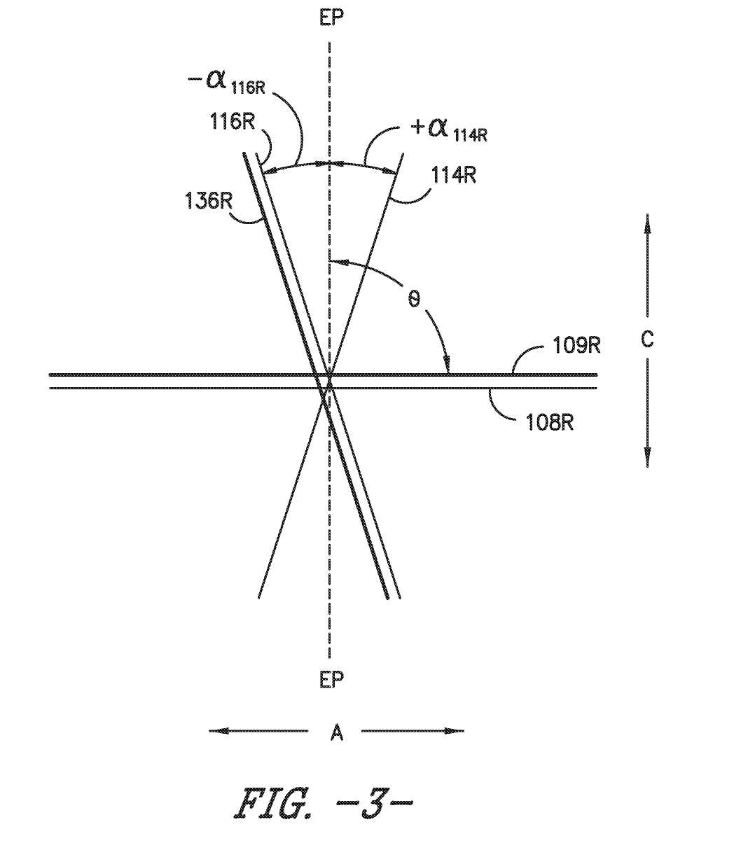

FIG. 1 is a schematic illustration of a tire 100 of the present invention. Tire 100 is shown in a cross-section taken along a meridian plane of the tire. The meridian plane includes the axis of rotation, which is parallel to axial direction A and about which tire 100 rotates during use. Radial direction R is orthogonal to axial direction A. As used herein, “radially-outward' refers to a radial direction away from the axis of rotation while “radially-inward” refers to a radial direction towards the axis of rotation. Circumferential direction C (FIGS. 2 and 3) is orthogonal to both radial direction R and axial direction A at any given point about the circumference of the tire, corresponds with the periphery of the tire, and is defined by the direction of rotation of the tire about the axis of rotation.

Tire 100 is symmetrical about the equatorial plane EP and, therefore, bisects tire 100 into opposing halves of substantially the same construction for which FIG. 1 depicts only one of the opposing halves. Accordingly, tire 100 includes a pair of opposing bead portions 102 and a pair of opposing sidewall portions 104 where only one of each pair is shown in FIG. 1 as will be readily understood by one of ordinary skill in the art. Tire 100 also includes a crown portion 106 connected to each opposing sidewall portion 104 and extending therebetween. A tread layer 118 forms the radially outermost portion of crown portion 106.

Referring to FIGS. 1 and 2, a body ply 108 extends from each bead portion 102, through each sidewall portion 104, and through the crown portion 106. As used herein, the term “ply” or “plies” refers to a layer or reinforcement of the tire and is not limited to a particular method of manufacturing a tire or the ply itself. For this particular embodiment, body ply 108 is of a radial reinforcement type meaning that it includes one or more reinforcing cords 108R (FIG. 2) that are parallel to each other and oriented at an angle of ±9 degrees or less from radial direction R along the sidewall portions 104 in the region of ends 110. Cords 108R are inextensible and may be constructed from e.g., a metal element or other inextensible materials. Each end 110 of body ply 108 is anchored in a respective bead portion 102. In certain embodiments, body ply 108 may be wrapped around a respective bead core 112 though such is not required.

Tire 100 includes a first working ply 114 and a second working ply 116, where second working ply 116 is positioned radially outward of first working ply 114. For this embodiment, first working ply 114 includes a plurality of first working ply reinforcements 114R that are parallel to each other within ply 114. Similarly, second working ply 116 includes a plurality of second working ply reinforcements 116R that are parallel to each other within ply 116.

FIG. 2 schematically depicts the relative orientation of reinforcements in various plies of tire 100 using only a single reinforcement for each ply for purposes of illustration. As shown, the first working ply reinforcements 114R and second working ply reinforcements 116R are crossed with respect to each other. More particularly, reinforcements 114R and 116R form an angle +α_{114R} and −α_{116R}, respectively, from the equatorial plane. In a typical left hand drive market, +α_{114R} has a positive value as shown in FIG. 2 while −α_{116R} has a negative value as shown in FIG. 2. In a right hand drive market, this orientation may be reversed such that α_{114R} has a negative value while α_{116R} has a positive value. The orientation of other reinforcements would be changed similarly between left hand and right hand drive markets. The use of negative angle designations for a denotes the orientation of the reinforcements relative to the equatorial plane as viewed from a perspective looking radially inward on the tire.

In one exemplary embodiment, the range of α is 10°≤|α_{114R}|≤45° for first working ply reinforcements 114R and is 10°≤|α_{116R}|45° for second working ply reinforcements 116R. First working ply 114 and second working ply 116 are both positioned radially outward of body 108 along crown portion 106.

In one particular embodiment, first working ply reinforcements 114R of first working ply 114 are constructed as inextensible 9.26 metal cords, wherein each cord includes 9 metal wires with each wire being 0.26 mm in diameter. For this embodiment, second working ply reinforcements 116R of second working ply 116 are also constructed as inextensible 9.26 metal cords, wherein each cord includes 9 metal wires with each wire being 0.26 mm in diameter. Other constructions may be used as well.

In certain embodiments of the invention, working ply 114 and working ply 116 have different widths along axial direction A. For example, the difference in widths along the axial direction may be the range of 10 mm to 30 mm. In certain embodiments, the first working ply 114 has the narrower axial width, W₁₁₄, as compared to the axial width, W₁₁₆ of second working ply 116. In one particular embodiment, tire 100 includes a first working ply 114 having an axial width W₁₁₄ of 366 mm and a second working ply 116 having an axial width W₁₁₆ of 344 mm.

Tire 100 includes a breaker ply 122 positioned radially outward of body ply 108 but radially inward of all other plies in crown portion 106. Breaker ply 122 has an axial width W₁₂₂, which is the width of breaker ply 122 along axial direction A. Breaker ply 122 includes a plurality of breaker ply reinforcement elements 122R (FIG. 2) arranged along a layer and parallel to each other. Each breaker ply reinforcement element 122R is continuous along its entire length L (FIG. 2)—i.e. is not broken into segments along its length L. Also, the length L of each breaker ply reinforcement element 122R does not exceed 155 mm. More particularly, if removed from tire 100, straightened, and measured along its length, each reinforcement element 122R would have a length L≤155 mm. In one exemplary embodiment, tire 100 is a size 445/50R22.5. In another embodiment, tire 100 is size 455/55R22.5 tire.

In one exemplary embodiment, each reinforcement element 122R is constructed from an inextensible cord. For example, breaker ply 122 may be constructed from a plurality of unbelted, inextensible 7.26 metal cords 122R, wherein each cord includes 7 metal wires with each wire being 0.26″ in diameter. By way of additional example, breaker ply 122 could also be 9.35 (9 wires of 0.35 mm diameter. Other cable sizes and configurations may be used as well.

In addition, each reinforcement element 122R within breaker ply 122 is at an angle θ from the equatorial plane EP where θ is 5°≤|θ|≤60°. In one particular embodiment, the range of θ is 35°≤|θ|≤60°. In another particular embodiment, the range of θ is 40°≤|θ|≤60°. In still another particular embodiment, |θ| is 40 degrees.

By way of contrast, FIG. 3 depicts a conventional construction of a tire where breaker ply 109 includes reinforcements 109R placed at an angle θ of 90 degrees from the equatorial plane EP. Part of the inventors' discovery is that by using a value of angle θ that in the range of 5°≤|θ|≤60° for the breaker ply reinforcements 108R, the BE of the tire can be increased. At the same time, as also discovered, surprisingly the axial width W of the breaker ply can be decreased from conventional constructions so as to reduce the overall mass and rolling resistance of the tire.

More particularly, the length L of the breaker ply can be maintained at L≤155 mm and at angles 5°≤|θ|≤60°, which has the effect of maintaining a lower axial width, W₁₂₂, of the breaker ply. Specifically, axial width, W₁₂₂, can be calculated as follows:

W₁₂₂ =L*(sin (θ)) Eq. 1

Substituting that L≤155 mm for breaker ply reinforcements 122R, the relationship becomes as follows:

W₁₂₂≤155*(sin (θ)) Eq. 2

Returning to FIGS. 1 and 2, in certain exemplary embodiments, tire 100 includes additional layers as well. For the embodiment shown, tire 100 includes a circumferential reinforcement layer 123 constructed from a plurality of circumferential reinforcement elements 123R (FIG. 2) positioned within crown portion 106. In FIG. 1, layer 123 is shown at a location along radial direction R that is between first working ply 114 and second working ply 116. In other embodiments of the invention, layer 123 may be positioned radially outward of body ply 108 and radially inward of first working ply 114. In still other embodiments, layer 123 may be positioned radially outward of body ply 108 and radially outward of second working ply 116.

Circumferential reinforcement elements 123R are positioned at an angle a from the equatorial plane |α|≤5 degrees. In certain embodiments, reinforcement elements 123R are positioned at an angle a of zero degrees i.e., parallel with equatorial plane EP or circumferential direction C. The layer 123 of a plurality of circumferential reinforcing elements 123R may be constructed from at least one extensible or inextensible cord, such as e.g., a metal cord, wound to form a spiral. The cords may be coated with a rubber compound before being laid. The rubber compound then penetrates the cord under the effect of pressure and the temperature when the tire is cured. In one embodiment of the invention, the reinforcing elements are metal reinforcing elements with a secant modulus at 0.7 percent elongation comprised between 10 and 120 GPa and a maximum tangent modulus of less than 150 GPa.

The moduli expressed hereinabove are measured on a curve of tensile stress as a function of elongation determined with a preload of 20 MPa brought down to the cross section of the metal of the reinforcing element, the tensile stress corresponding to a measured tension brought down to the cross section of metal of the reinforcing element. The moduli of the same reinforcing elements can be measured on a curve of tensile stress as a function of elongation determined with a preload of 10 MPa brought down to the overall cross section of the reinforcing element, the tensile stress corresponding to a measured tension brought down to the overall cross section of the reinforcing element. The overall cross section of the reinforcing element is the cross section of a composite element made of metal and of rubber, the latter notably having penetrated the reinforcing element during the tire curing phase.

Circumferential reinforcements 123R may be straight—i.e. linear—or may have a wavy shape along their length. For example, in one exemplary embodiment, the circumferential reinforcement elements 123R include metal reinforcement elements that are wavy and have a ratio A/λ of an amplitude A to the wavelength λ in the range of 0<(A/λ)≤0.09.

Circumferential reinforcement elements 123R of layer 123 may be divided into discrete zones of different pace, and such zones may be positioned symmetrically about the equatorial plane EP. Each zone may be a single ply or a plurality of plies. For example, in FIG. 1, tire 100 includes 5 zones of varying pace that are positioned symmetrically about equatorial plane EP including a central zone 126, a pair of opposing intermediate zones 128 separated along axial direction A by central zone 126, and a pair of opposing, axially outermost zones 130 separated along axial direction A by central zone 126 and intermediate zones 128.

In one exemplary embodiment, the pace of reinforcement elements 123R in central zone 126 is 1 to 1.5 times the pace of reinforcement elements 123R in axially outermost zones 130, and the pace of the reinforcement elements 123R in opposing intermediate zones 128 is 1.6 to 2 times the pace of reinforcement elements 123R in axially outermost zones 130. In another exemplary embodiment, the pace of the reinforcement elements 123R in opposing intermediate zones 128 is 1.0 to 2 times the pace of reinforcement elements 123R in axially outermost zones 130.

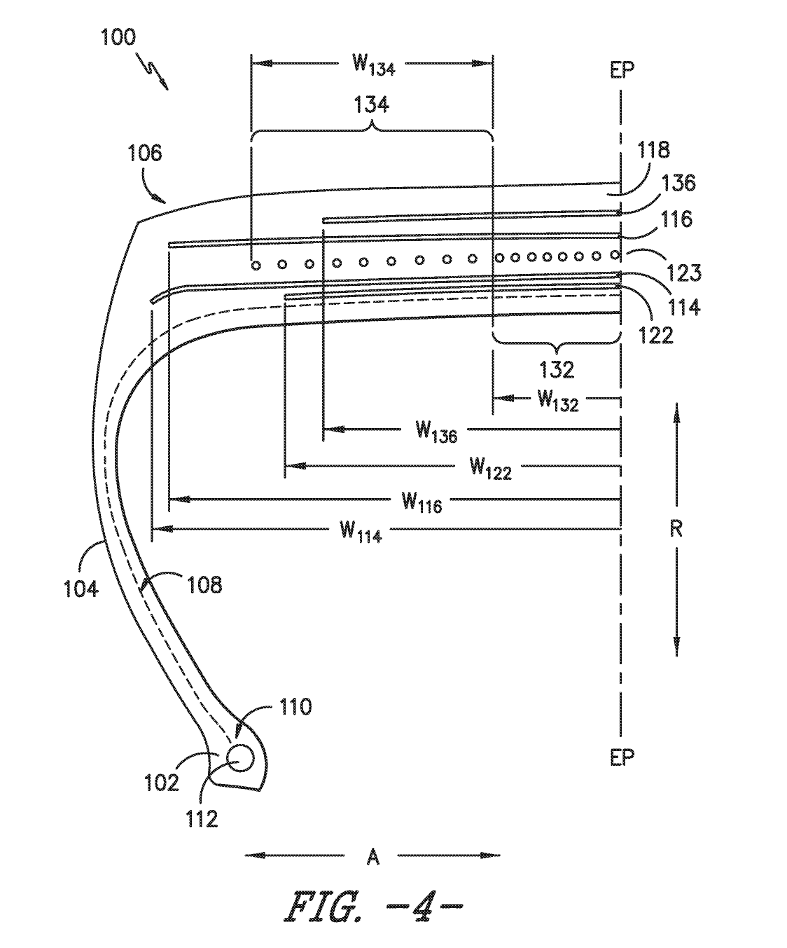

FIG. 4 provides another exemplary embodiment of the present invention similar to the embodiment of FIG. 1. However, in FIG. 4, tire 100 includes a circumferential reinforcement layer 123 having three zones of circumferential reinforcements 123R of varying pace. As before, each zone may be a single ply or a plurality of plies. More particularly, in this embodiment, layer 123 includes a central zone 132 and a pair of opposing lateral zones 134. By way of example, central zone 132 may have reinforcement elements having a pace of 1 to 3 times the pace of reinforcements 134 in lateral zones.

For both embodiments of tire 100 shown in FIGS. 1 and 4, tire 100 can include a protector ply 136 positioned radially outward of both the second working ply 116 and circumferential reinforcing layer 123. Protector ply 136 may be constructed from metal cords. For example, protector ply 136 may include metal cords 136R (FIG. 2) at an angle a of 18 degrees from the equatorial plane EP. Such cords may be constructed as 6.35 metal cords, wherein each cord includes 6 metal wires with each wire being 0.35 mm in diameter.

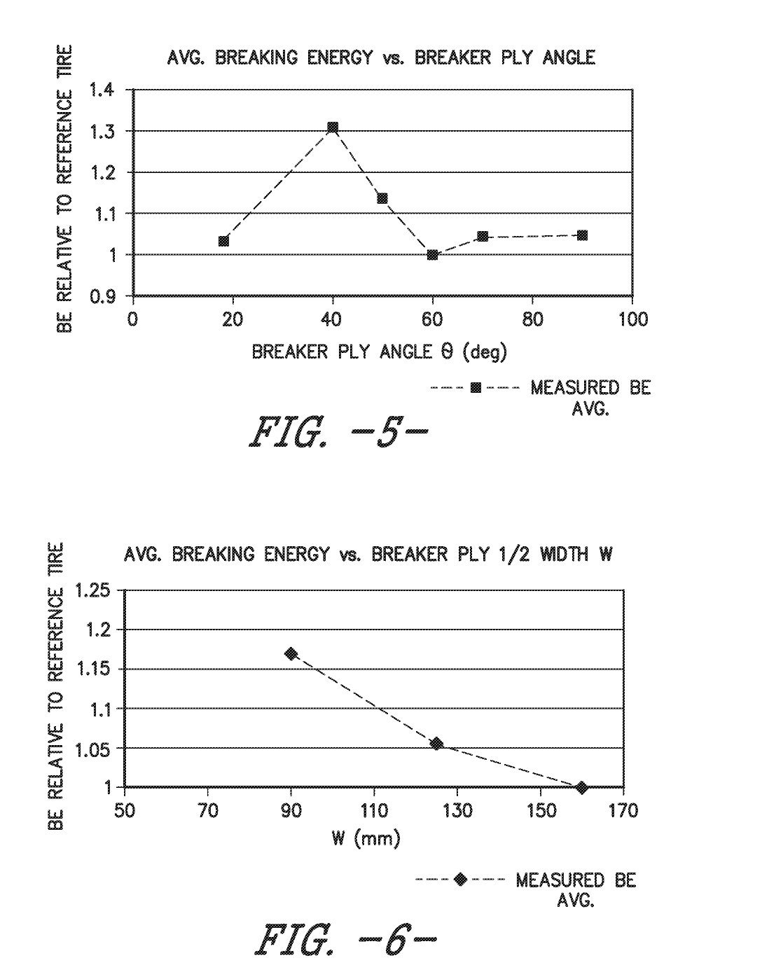

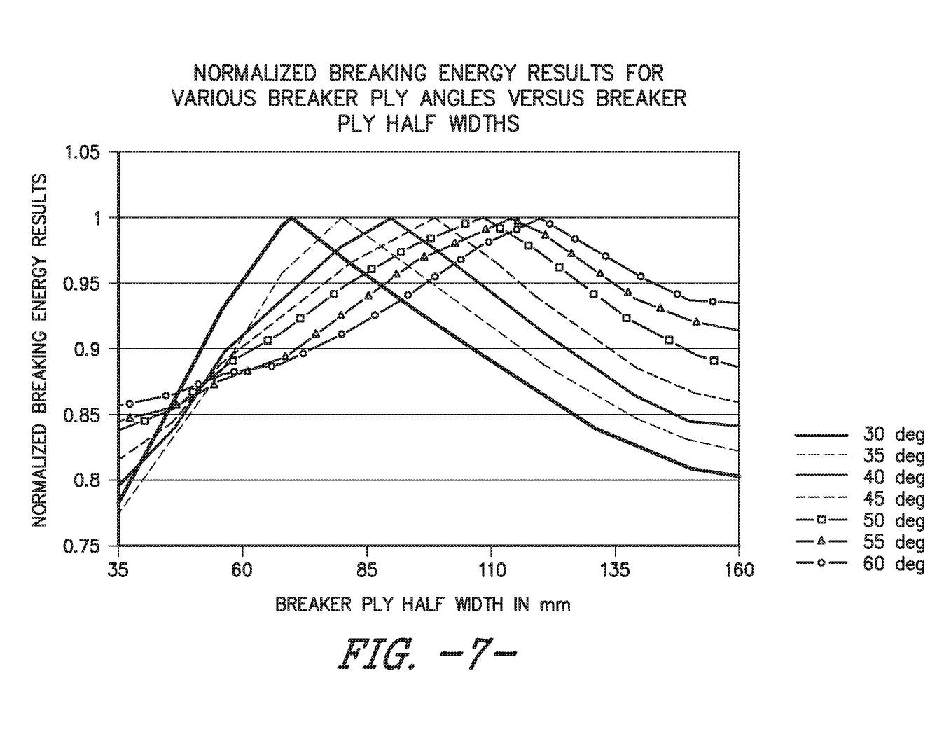

FIG. 5 provides a plot of the measured breaking energy BE of two test tires of nominally identical construction averaged together at each breaker ply angle plotted. The test tires, all of size 445/50R22.5. were of all of nominally identical construction with a breaker ply 122 having reinforcements 122R at different angles θ from the equatorial plane EP (e.g., FIG. 2) as shown. The working plies and protector ply angles all used a value of angle θ=18° and the body ply was at angle θ=90°. The BE of the reference tire is normalized at 1.0 for comparison purposes. Accordingly, as shown in FIG. 6, the BE measured as described above for the average of test tires surprisingly increased as angles θ decreased from 60 degrees and showed a peak around 40 degrees.

FIG. 6 is a plot of the BE of the average of test tires relative to the reference tire as a function of ½ the axial width W₁₂₂ of breaker ply 122 and using a breaker ply with angle θ=60°. As shown in FIG. 6, the BE measured as described above for the average of test tires surprisingly increases as W₁₂₂ decreased from 160 mm to 90 mm.

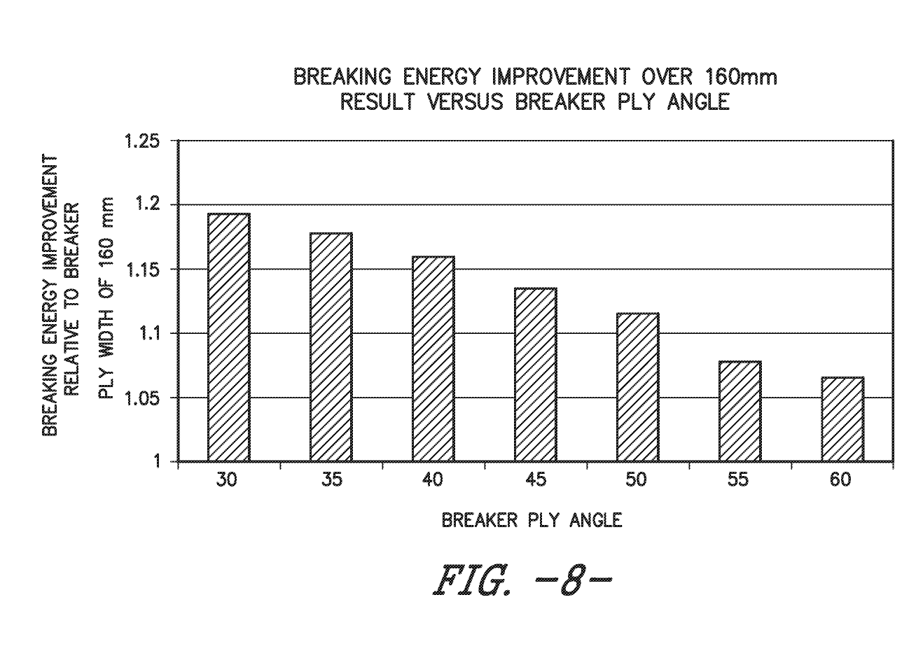

FIGS. 7 and 8 show the result of FEA (finite element analysis) simulations carried out on a production tire of 445/50R22.5 dimension. The construction of the production tire is similar to FIG. 1 with a five zone, zero degree ply and a body ply angle of θ=90°. However, each zone had the same pace of 2 mm.

FIG. 7 shows the normalized breaking energy as a function of breaker ply angles vs. breaker ply half width W₁₂₂. The optimum for a given angle is thus achieved when the normalized BE is equal to 1. For example, as will be clear to one of ordinary skill in the art using the teachings disclosed herein, an angle θ of 60° for the reinforcements of the breaker ply offers near-maximum gains in BE gains if the breaker ply half-width W₁₂₂ is reduced to about 65 mm. Such is achieved with considerable gains in mass reduction, improved rolling resistance and other performances.

FIG. 8 shows the normalized BE improvement over a breaker ply half-width . W₁₂₂ of 160 mm as a function of angle θ for the breaker ply reinforcements 122R. The maximum BE is seen to increase with decreasing angle θ, a result consistent with θ=60° having the lowest BE performance of any angle.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

1. A tire defining axial, circumferential, and radial directions, the tire having an equatorial plane, the tire comprising:
a pair of opposing bead portions;
a pair of opposing sidewall portions, each sidewall portion connected with a bead portion;
a crown portion connected between opposing sidewall portions;
a body ply extending between the bead portions and through the opposing sidewall portions and crown portion;
a breaker ply positioned in the crown portion and radially outward of the body ply;
a first working ply positioned in the crown portion and radially outward of the breaker ply; and
a second working ply positioned in the crown portion and radially outward of the first working ply;
a layer of circumferential reinforcement elements positioned in the crown layer:
wherein the breaker ply has an axial width and comprises a plurality of breaker ply reinforcement elements that each extends continuously across the entire axial width of the breaker ply and have a length L of no more than 155 mm, at an angle θ from the equatorial plane, wherein the range of θ is 5°≤θ≤60°.

2. The tire of claim 1, wherein the range of θ is 35°≤θ≤60°.

3. The tire of claim 1, wherein the range of θ is 40°≤θ≤60°.

4. The tire of claim 1, wherein θ is 40°.

5. The tire of claim 1, wherein the breaker ply has a width, W, along the axial direction of W₁₂₂≤Lₘₐₓ*(sin (θ)), where Lₘₐₓ=155 mm is the maximum length of the breaker ply reinforcement elements.

6. The tire of claim 1, wherein the first working ply comprises a plurality of first working ply reinforcement elements making angles α in the range of 10°≤|α≤45° with the equatorial plane.

7. The tire of claim 6, wherein the second working ply comprises a plurality of second working ply reinforcement elements making angles a in the range of 10°≤|α|≤45° with the equatorial plane and arranged to cross the first working ply reinforcement elements at an opposite angle a from the equatorial plane.

8. (canceled)

9. The tire of claim 1, further comprising a layer of circumferential reinforcement elements positioned in the crown layer, the circumferential reinforcement elements divided along the axial direction into a plurality of discrete zones of varying pace.

10. The tire of claim 9, wherein a pace distribution amongst the plurality of discrete zones is symmetrical about the equatorial plane of the tire.

11. The tire of claim 10, wherein the layer of circumferential reinforcement elements is positioned radially inward of the first working ply.

12. The tire of claim 10, wherein the layer of circumferential reinforcement elements is positioned radially outward of the second working ply.

13. The tire of claim 10, wherein the layer of circumferential reinforcement elements is positioned along the radial direction between the first working ply and the second working ply.

14. The tire of claim 10, wherein the layer of circumferential reinforcement elements positioned in the crown layer comprises three zones of varying pace including a central zone and a pair of opposing lateral zones separated by the central zone.

15. The tire of claim 14, wherein the pace of the circumferential reinforcement elements in the central zone is 1 to 3 times the pace of the circumferential reinforcements in the opposing lateral zones.

16. The tire of claim 10, wherein the layer of circumferential reinforcement elements positioned in the crown layer comprises five zones of varying pace including a central zone, a pair of opposing intermediate zones separated by the central zone, and a pair of axially outermost zones separated by the central zone and the opposing intermediate zones.

17. The tire of claim 16, wherein the pace of the circumferential reinforcement elements in the central zone is in the range of 1 to 1.5 times the pace of the axially outermost zones and, and wherein the pace of the opposing intermediate zones is 1.6 to 2 times the pace of the circumferential reinforcements in the axially outermost zones.

18. The tire of claim 10, wherein the circumferential reinforcement elements comprise metal reinforcement elements that are wavy and have a ratio A/λ of an amplitude A to the wavelength λ in the range of 0<(A/λ)≤0.09.

19. The tire of claim 10, further comprising a protector ply positioned radially outward of the second working ply and the layer of circumferential reinforcements, the protector ply comprising protector ply reinforcements at an angle nominally equal to the second working ply from the equatorial plane.
